(19) United States
(12) Patent Application Publication
(10) Pub. No.: US 2015/0022690 A1
(43) Pub. Date: Jan. 22, 2015

(54) INFORMATION DISPLAYING APPARATUS

(71) Applicant: NIKON CORPORATION, Tokyo (JP)

(72) Inventors: Satoshi EJIMA, Tokyo (JP); Akihiko HAMAMURA, Chiba-shi (JP)

(73) Assignee: NIKON CORPORATION, TOKYO (JP)

(21) Appl. No.: 14/511,914

(22) Filed: Oct. 10, 2014

Related U.S. Application Data
(63) Continuation of application No. 12/923,715, filed on Oct. 5, 2010, now abandoned.
Application No. 12/923,715 is a continuation of application No. 11/260,161, filed on Oct. 28, 2005, now abandoned.
Application No. 11/260,161 is a continuation of application No. 09/950,689, filed on Sep. 13, 2001, now abandoned.
Application No. 09/950,689 is a continuation of application No. 08/965,422, filed on Nov. 6, 1997, now abandoned.
(60) Provisional application No. 60/052,993, filed on Jul. 11, 1997.

(30) Foreign Application Priority Data
Feb. 14, 1997 (JP) 9-029994

(51) Int. Cl. H04N 1/21; G06F 3/0485

(52) U.S. Cl. CPC H04N 1/2125; G06F 3/04855
USPC 348/231.2

(57) ABSTRACT

Recorded information is grouped in recording units. The information of each recording unit is displayed by the order of older recording date based upon information recorded in memory. The recording time of each recording unit is displayed on the left edge of the display screen, to the right of which is a memo icon indicating memo information, a thumbnail image indicating shooting image information, a sound icon indicating sound, and reproduction time information for each recording unit. If a predetermined recording unit is designated and reproduced, the screen is re-displayed so that the reproduced recording unit appears at the lowermost line of the screen. If a new recording unit is recorded, the newest recording unit is displayed at the lowermost line. If the screen is scrolled and another display screen is displayed by operation of a scroll key, a screen similar to the previously displayed screen is displayed.

### CROSS-REFERENCE TO RELATED APPLICATIONS

This is a Continuation of application Ser. No. 12/923,715 filed Oct. 5, 2010, which in turn is a Continuation of application Ser. No. 11/260,161 filed Oct. 28, 2005, which in turn is a Continuation of application Ser. No. 09/950,689 filed Sep. 13, 2001, which in turn is a Continuation of application Ser. No. 08/965,422 filed Nov. 6, 1997, which claims the benefit of U.S. Provisional Application No. 60/052,993 filed Jul. 11, 1997. The disclosures of the prior applications are hereby incorporated by reference herein in their entireties.

### INCORPORATION BY REFERENCE

The disclosure of the following priority application is herein incorporated by reference in its entirety: Japanese Patent Application No. 9-029994, filed Feb. 14, 1997, which the present application claims priority thereto.

### BACKGROUND

1. Field of Invention

The invention relates to an information processing apparatus. In particular, it relates to an information processing apparatus which processes information stored as recording units which can include image information from a photographed object, memo information which is input as a line-drawing and/or sound information which is input through a microphone.

2. Description of Related Art

With a conventional electronic camera, when photographed images are reproduced, the images are reproduced in the order in which they were recorded. Hence, conventional apparatus experience a problem when it is desired to verify (review) newly recorded information when additional information was previously recorded in memory. In particular, it can take a long time to review the newly recorded information because all of the information is reproduced in the order in which it was recorded. Thus, a user may have to wait an undesirably long time to review the newly recorded information.

### SUMMARY

Considering the problem described above, it is an object of the invention to provide a system with a high level of operability in the reproduction of information, including images recorded by, for example, an electronic camera.

According to one aspect of the invention, an information processing apparatus includes recording means for recording information such as, e.g., images, memos and/or sound as recording units. A table creation means is provided for creating a table that lists the recording units recorded in the recording means. An input means is operated to cause the table created by the table creation means to be displayed on a display. An output means outputs on the display, when the input means inputs a predetermined input, a portion of the table created by the table creation means. A detection means detects the recording of a new recording unit in the recording means. When the detection means detects the recording of the new recording unit in the recording means and when the input means inputs the predetermined input, the output means outputs on the display the portion of the table containing the newly recorded recording unit.

### BRIEF DESCRIPTION OF THE DRAWINGS

The invention will be described in conjunction with the following drawings in which like reference numerals designate like elements and wherein:

FIG. 1 shows a perspective view of the front of an electronic camera, which is an information processing apparatus according to an embodiment of the invention;

FIG. 2 shows a perspective view of the back of the FIG. 1 apparatus;

FIG. 3 shows a perspective view of the FIG. 1 electronic camera with the LCD cover closed;

FIG. 4 shows a perspective view showing the inside of the FIG. 1 electronic camera;

FIGS. 5A-5C show various positional relationships between a pin on the LCD cover and a switch according to an embodiment of the invention;

FIG. 6 shows a block diagram of the internal electrical structure of the FIG. 1 electronic camera;

FIG. 7 shows the thinning process of the pixels during the L mode according to an embodiment of the invention;

FIG. 8 shows the thinning process of the pixels during the H mode according to an embodiment of the invention;

FIG. 9 shows an example of the display screen of the FIG. 1 electronic camera;

FIG. 10 is a flow chart showing a process executed according to an embodiment of the invention;

FIG. 11 is a flow chart showing a playback mode process according to an embodiment of the invention;

FIG. 12 is a flow chart shows a scroll process according to an embodiment of the invention;

FIG. 13 shows a sample display screen which is displayed by the process shown in FIG. 10; and

FIG. 14 shows another sample display screen which is displayed by the process shown in FIG. 10.

### DETAILED DESCRIPTION OF PREFERRED EMBODIMENTS

An embodiment of the present invention is described hereafter, with reference to the drawings.

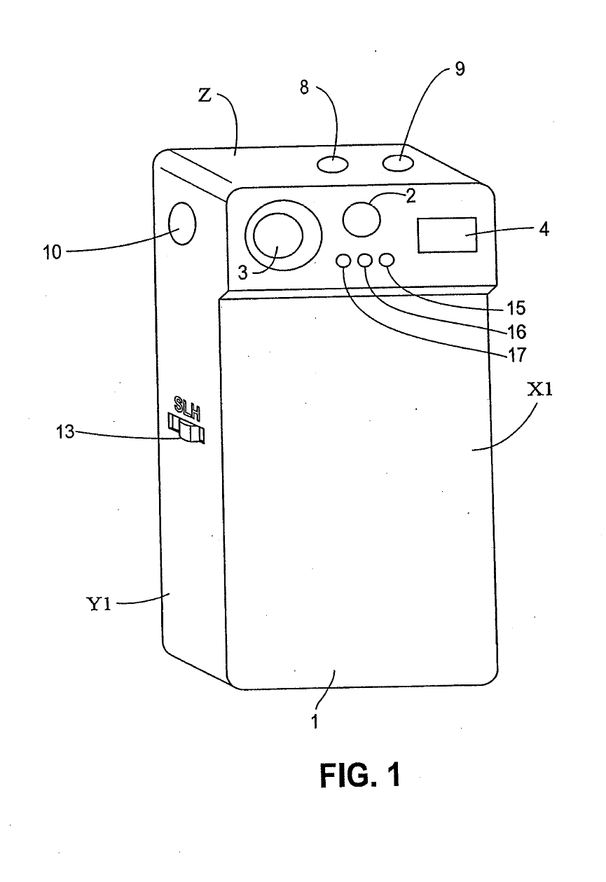

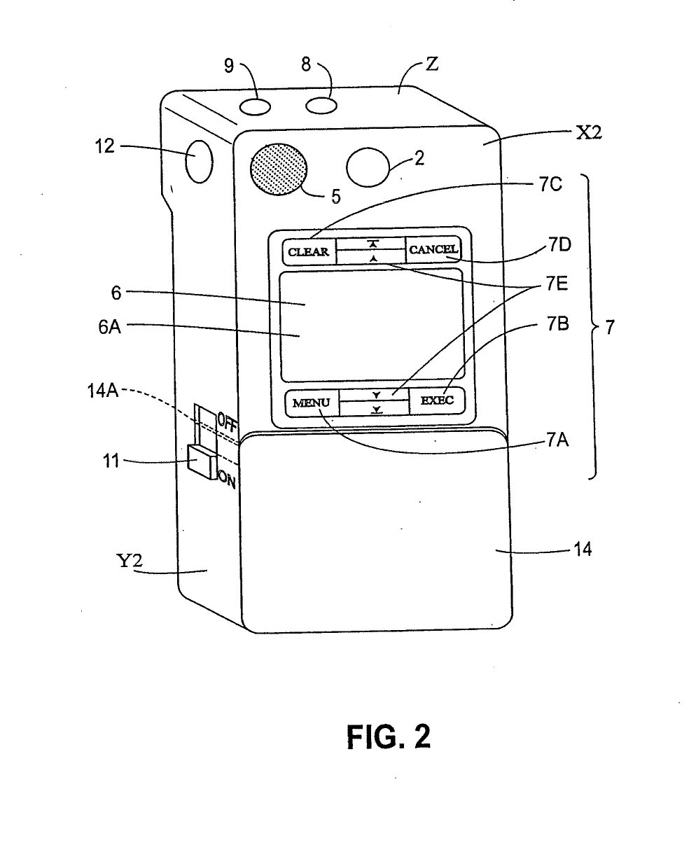

FIG. 1 and FIG. 2 are perspective views showing structural examples of an embodiment of an electronic camera according to the invention. In the electronic camera, the camera surface facing an object is defined as surface X1 and the camera surface facing the user when an object is photographed is defined as surface X2. A viewfinder 2 is located on the top edge section of the surface X1, and is used to verify the shooting range of the object. A shooting lens 3, which takes in the optical image of the object, and a light emitting unit (strobe) 4, which emits light to illuminate the object, are also provided on the top edge section of the surface X1.

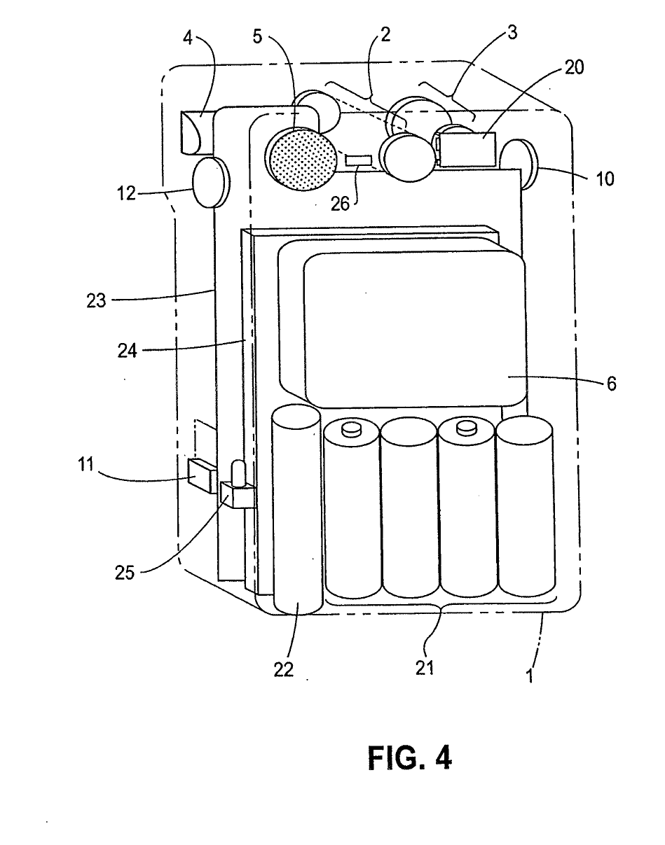

Additionally provided on the surface X1, are a photometry device 16, a red-eye reducing lamp 15 and a colorimetric device 17. The photometry device 16 measures light during the time that the red-eye reducing lamp 15 is operated to reduce red eye by emitting light before causing the strobe 4 to emit light. A CCD 20 (FIG. 4) is prevented from imaging the object when the red-eye reducing lamp 15 is operating. A colorimetric device 17 also measures color during the time when operation of the CCD 20 is prevented.

Also provided on the top edge section of surface X2 (a position corresponding to the top section of surface X1 where viewfinder 2, control lens 3 and the light emitting unit 4 are formed) which faces the surface X1, are a viewfinder 2 and a speaker 5, which outputs sound recorded in the electronic camera 1. LCD 6 and control keys 7 are formed on surface X2 below viewfinder 2, shooting lens 3, light emitting unit 4 and speaker 5. A touch tablet 6A, which functions as an input means and designation means, is positioned on the surface of the LCD 6. Touch tablet 6A outputs position data corresponding to the position designated by the touching operation of a pen type pointing device. This is explained in detail hereafter.

The touch tablet 6A is made of transparent material, such as glass or resin so that the user can view an image displayed on LCD 6, which is formed beneath touch tablet 6A, through touch tablet 6A.

Control keys 7 can be operated in order to reproduce and display recording data on LCD 6. Control keys 7 accommodate the detection operation (input) by the user and supply the user's input to the CPU 39.

Menu key 7A is operated in order to display the menu screen on LCD 6. Execution key 7B is operated in order to reproduce recording information selected by the user.

Clear key 7C is operated in order to delete recorded information. Cancel key 7D is operated in order to interrupt the reproduction process for the recording information. Scroll key 7E (which functions as a second input means) is operated for scrolling the screen vertically when recording information is displayed on the LCD 6 as a table.

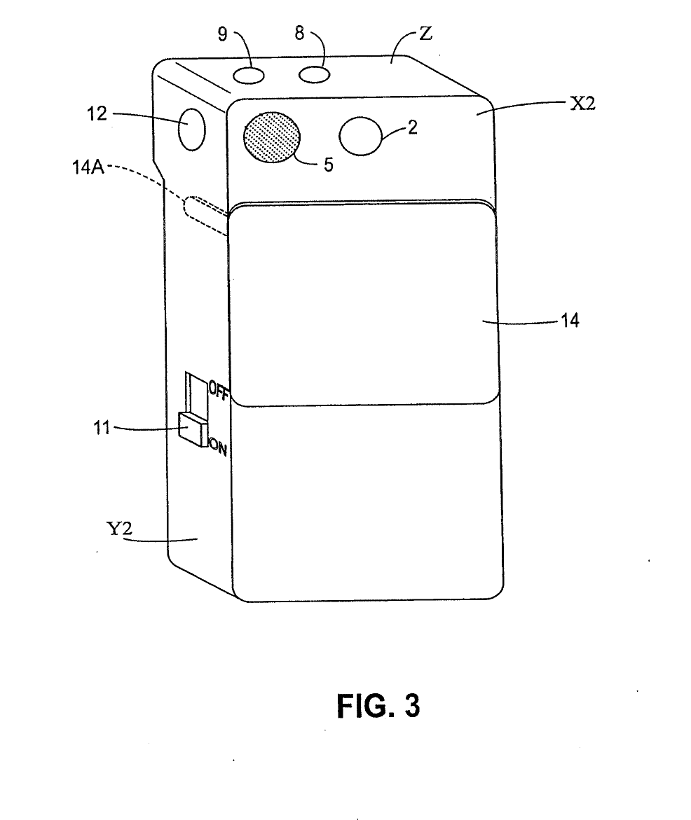

LCD cover 14, which slides freely, is provided on surface X2 to protect the LCD 6 when it is not in use. When moved vertically upward, LCD cover 14 covers LCD 6 and touch tablet 6A, as shown in FIG. 3. When LCD cover 14 is moved vertically downward, LCD 6 and touch tablet 6A are exposed, and power switch 11, which is arranged on surface Y2, is switched to the on-position by arm member (a pin) 14A of LCD cover 14.

A microphone 8, for gathering sound, and an earphone jack 9, to which an unrepresented earphone is connected, are provided on surface Z, which includes the top surface of the electronic camera 1.

Release switch 10, which is operated when shooting an object, and continuous shooting mode switch 13, which is operated when switching the continuous shooting mode during shooting, are provided on surface Y1. Release switch 10 and continuous shooting mode switch 13 are positioned vertically below viewfinder 2, shooting lens 3 and light emitting unit 4, which are positioned on the top edge section of surface X1.

Recording switch 12, which is operated in order to record sound, and power switch 11 are provided on surface Y2 (the right surface) which faces surface Y1. As with release switch 10 and continuous shooting mode switch 13 described above, recording switch 12 and power switch 11 are vertically positioned below viewfinder 2, shooting lens 3 and light emitting unit 4, which are positioned on the top edge section of surface X1. Additionally, recording switch 12 positioned on surface Y2 and release switch 10 positioned on surface Y1 are formed at virtually the same height so that the user does not feel a difference when the camera is held either by the right or left hands.

Alternatively, the height of the recording switch and the release switch 10 may be intentionally made different to prevent the user from accidentally pressing the switch provided on the opposite side surface when the other switch is pressed and the user's fingers hold the opposite side surface to offset the moment created by pressing the switch.

The continuous shooting mode switch 13 is used when the user decides to shoot one frame or several frames of the object by pressing the release switch 10. For example, if the continuous shooting mode switch indicator is pointed to the position printed “S” (in other words, when the switch is changed to the S mode), and the release switch 10 is pressed, the camera shoots only one frame.

If the indicator of the continuous shooting mode switch indicator is pointed to the position printed “L” (in other words, when the switch is changed to the L mode), and the release switch 10 is pressed, the camera shoots eight frames per second as long as the release switch 10 is pressed. Thus, the low speed continuous shooting mode is enabled.

Furthermore, if the continuous shooting mode switch indicator is pointed to the position printed “H” (in other words, when the switch is changed to H mode), and the release switch 10 is pressed, the camera shoots 30 frames per second as long as the release switch 10 is pressed. Thus, the high speed continuous shooting mode is enabled.

The internal structure of the electronic camera 1 is described next. FIG. 4 is a perspective view showing an example of the internal structure of the electronic camera shown in FIGS. 1 and 2. A CCD 20 is provided close to surface X2 behind the shooting lens 3. The optical image of the object imaged through the shooting lens 3 is photoelectrically converted to electric signals by the CCD 20.

A display device 26 located inside the viewfinder is arranged inside the vision screen of the viewfinder 2 and is capable of displaying various setting conditions for various functions for viewing by the user who views an object through the viewfinder 2.

Four cylindrical batteries 21 (for example, AA dry cell batteries) are placed side by side vertically below the LCD 6 and the electric power stored in the batteries 21 is supplied to the various components of the device. A capacitor 22 is provided below the LCD 6 and next to the batteries 21 to store an electric charge which is used to power the light emitting unit 4 so that light is emitted.

Various control circuits are formed on the circuit board 23 to control each component of the electronic camera 1. A removable memory card 24, which functions as a first recording means and as a second recording means, is provided between the circuit board 23, the LCD 6 and the batteries 21 so that information input into the electronic camera 1 is recorded in preassigned areas of the memory card 24.

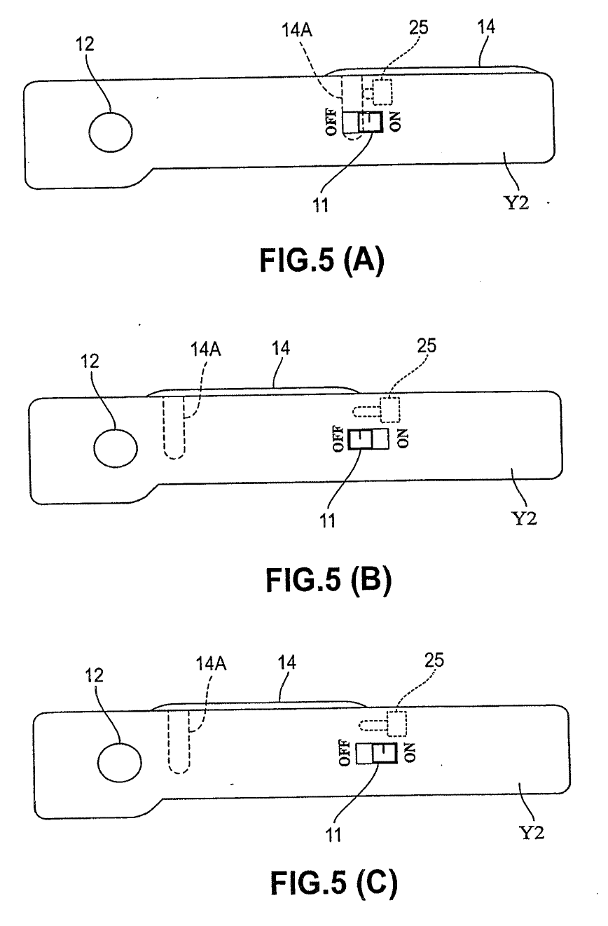

LCD switch 25, which is positioned adjacent to the power source switch 11, turns on only when the switch is pressed and is switched to the ON position. The power source switch 11 is engaged by the arm member 14A of the LCD cover 14 when the LCD cover 14 is moved vertically downward, as shown in FIG. 5A.

If the LCD cover 14 moves vertically upward, the power source switch 11 can be operated by the user independent of the LCD switch 25. For example, if the LCD cover 14 is closed and the electronic camera 1 is not used, the power source switch 11 and the LCD switch 25 are placed in the off-mode as shown in FIG. 5B. In this mode, if the user switches the power source switch 11 to the on-mode as shown in FIG. 5C, the power source switch 11 is set in the on-mode, but the LCD switch 25 continues to be in the off-mode. On the other hand, when the power source switch 11 and the LCD switch 25 are in the off-mode, as shown in FIG. 5B, and if the LCD cover is opened, the power source switch 11 and the LCD switch 25 are set in the on-mode as shown in FIG. 5A. Then, when the LCD cover 14 is closed, only the LCD switch 25 is set in the off-mode as shown in FIG. 5C.

According to an embodiment of the invention, the memory card 24 is removable, but a memory in which various information can be recorded may also be provided on the circuit board 23. Moreover, various information recorded in the memory (memory card 24) may be output to an external personal computer through an interface 48.

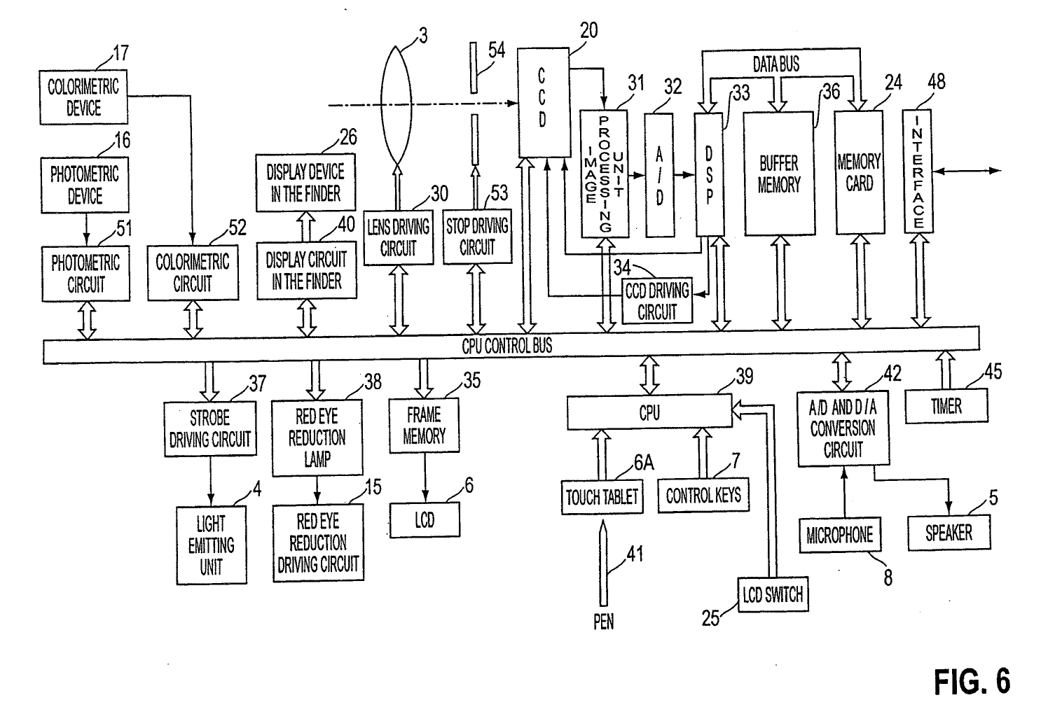

An internal electric structure of the electronic camera 1 according to an embodiment of the invention is described hereafter, with reference to the block diagram shown in FIG. 6. The CCD 20, which includes a plurality of pixels, photoelectrically converts the light image imaged on each pixel into image signals (electric signals). The digital signal processor (hereinafter “DSP”) 33, which functions as a reproduction means, supplies the CCD with a horizontal driving pulse and a vertical driving pulse by controlling the CCD driving circuit 34.

The image processing unit 31 is controlled by the CPU 39, and samples image signals which are photoelectrically converted by the CCD 20 with a predetermined timing, and amplifies the sampled signals to a predetermined level. The analog/digital conversion circuit (hereinafter “the A/D conversion circuit”) 32 digitizes the image signals which are sampled by the image processing unit 31 and supplies them to the DSP 33.

The DSP 33, which controls the buffer memory 36 and the data bus connected to the memory card 24, temporarily stores image data which is supplied from the A/D conversion circuit 32 in the buffer memory 36, reads the image data stored in the buffer memory 36, and records image data in the memory card 24.

The DSP 33 accesses frame memory 35, which functions as an output means, to store image data supplied by the A/D conversion circuit 32, display image data on the LCD 6, read the shooting image data from the memory card 24, decompress the shooting data, and then store the decompressed image data in the frame memory 35, to display the decompressed image data on the LCD 6.

DSP 33 also operates the CCD 20 by repeatedly adjusting the exposure time, i.e., the exposure value, until the exposure level of the CCD 20 reaches an appropriate level when starting the electronic camera 1. At this time, the DSP 33 may first operate the photometry circuit 51, and then compute the initial exposure time value of the CCD 20, which corresponds to a light receiving level detected by the photometry device 16. Adjustment of exposure time for the CCD 20 may, therefore, be achieved in a short amount of time. In addition, the DSP 33 executes timing management for data input/output during recording on memory card 24 and storing decompressed image data on buffer memory 36.

The buffer memory 36 is used to ease the difference between the data input/output speed for the memory card 24 and the processing speed at the CPU 39 and the DSP 33. The microphone 8 inputs sound information, i.e., gathered sound and supplies the sound information to the A/D and D/A conversion circuit 42.

The A/D and D/A conversion circuit 42 converts the analog signals to digital signals, then supplies the digital signals to the CPU 39, changes the sound data supplied by the CPU 39 to analog signals, and outputs the sound signal, which has been converted to an analog signal, to the speaker 5.

Photometry device 16 measures the light amount of the object and its surrounding area and outputs the measurement results to the photometry circuit 51. Photometry circuit 51 executes a predetermined process on the analog signals which include measurement results supplied from the photometry device 16, and converts them to digital signals and outputs the digital signals to the CPU 39.

The color measuring (colorimetry) device 17 measures the color temperature of the object and its surrounding area and outputs the measurement result to the colorimetry circuit 52. The colorimetry circuit 52 executes a predetermined process on the analog signals which includes the color measurement results supplied from the color measuring device 17, converts them to digital signals and outputs the digital signals to the CPU 39.

The timer 45 has an internal clock circuit and outputs data corresponding to the current time to the CPU 39. The stop driving circuit 53 sets the diameter of the aperture stop 54 to a predetermined value. The stop 54 is arranged between the shooting lens 3 and the CCD 20 and changes the aperture for light entering from the shooting lens 3 to the CCD 20.

The CPU 39 prevents operation of the photometry circuit 51 and the colorimetry circuit 52 when the LCD cover 14 is open, causes operation of the photometry circuit 51 and the colorimetry circuit 52 when the LCD cover 14 is closed, and prevents the operation of the CCD 20, i.e., electronic shutter operation, until the release switch 10 reaches the half-depressed position.

The CPU 39 receives light measurement results from the photometry device 16, and receives color measurement results from the colorimetry device 17 by controlling the photometry circuit 51 and the colorimetry circuit 52 when the CCD 20 operation is stopped.

The CPU 39 also computes a white balance adjustment value using a predetermined table, which corresponds to the color temperature supplied from the colorimetry circuit 52, and supplies the white balance value to the image processing unit 31.

In other words, when the LCD cover 14 is closed, the LCD 6 is not used as an electronic viewfinder and hence, CCD 20 operation is stopped. The CCD 20 consumes a large amount of electric power, hence by stopping the operation of the CCD 20 as described above, the battery power is conserved. When the LCD cover 14 is closed, the image processing unit 31 is controlled in such manner that the image processing control unit 31 does not execute various processes until the release switch 10 is operated, i.e., until the release switch 10 reaches the half-depressed state. When the LCD cover 14 is closed, the stop driving circuit 53 is controlled in such a manner that the stop driving circuit 53 does not execute operations, such as changing the diameter of the aperture stop 54, until the release switch 10 is operated, i.e., until the release switch 10 reaches the half-depressed state.

The CPU 39 causes the strobe 4 to emit light at the user's discretion, by controlling the strobe driving circuit 37, and also causes the red eye reduction lamp 15 to emit light, at the user's discretion, prior to causing the strobe 4 to emit light by controlling the red eye reduction lamp driving circuit 38. In this instance, the CPU 39 prevents the strobe 4 from emitting light when the LCD cover 14 is open, in other words, when the electronic viewfinder is used. By so doing, the object may be shot as an image displayed in the electronic viewfinder.

The CPU 39 records information, including the date of shooting, as header information of the image data in a shooting image recording area of the memory card 24, according to the date data supplied from the timer 45. In other words, date data is attached to the shooting image data recorded in the shooting image recording area of the memory card 24.

Additionally, the CPU 39 temporarily records the digitized and compressed sound data after compressing the digitized sound information to the buffer memory 36, and then records it in a predetermined area, i.e., sound recording area, of the memory card 24. The data concerning the recording date is also recorded in the sound recording area of the memory card 24 as header information of the sound data.

The CPU 39 executes the auto focus operation by controlling the lens driving circuit 30 to move the shooting lens 3, and by changing the aperture diameter of the stop 54, which is positioned between the shooting lens 3 and the CCD 20, by controlling the stop driving circuit 53.

The CPU 39 also displays settings for various operations on the display device 26 located inside the viewfinder by controlling the display circuit 40 inside the viewfinder.

The CPU 39 exchanges data with external apparatus (unrepresented) through an interface (I/F) 48. The CPU 39 receives signals from the control keys 7 and processes them appropriately.

When a predetermined position on the touch tablet 6A is pressed by the pen 41, i.e., a pen type pointing member operated by the user, the CPU 39 reads the X-Y coordinates of the position being pressed by the touch tablet 6A and stores the coordinate data, i.e., line drawing information described in greater detail later, in buffer memory 36. The CPU 39 records line drawing information stored in the buffer memory 36 in the line drawing information recording area of the memory card 24, together with header information including the line drawing information input date.

Next, various operations of the electronic camera 1 according to an embodiment of the invention will be described. The operation of the electronic viewfinder in LCD 6 will first be described in detail.

When the user half-depresses the release switch 10, the DSP 33 determines whether or not the LCD cover 14 is open based on the value of the signal corresponding to the status of the LCD switch 25, which is supplied from CPU 39. If LCD cover 14 is determined to be closed, the operation of the electronic viewfinder is not executed. In this case, DSP 33 stops the process until the release switch 10 is operated. If the LCD cover 14 is closed, the operations of the electronic viewfinder are not executed and hence, CPU 39 stops CCD 20 operation, the image processing unit 31 operation and stop driving circuit 53 operation. The CPU 39 causes photometry circuit 51 and colorimetry circuit 52 to operate, and supplies the measurement results to the image processing unit 31. The image processing unit 31 uses the measurement result values to control the white balance and the brightness value. If the release switch 10 is operated, the CPU 39 prevents CCD 20 and the stop driving circuit 53 from operating.

On the other hand, if the LCD cover 14 is open, the CCD 20 executes the electronic shutter operation with a predetermined exposure time for each predetermined time interval, executes photoelectric conversion of the photo image of the object, which is gathered by the shooting lens 3, and outputs the resulting image signals to the image processing unit 31.

The image processing unit 31 controls the white balance and the brightness value, executes predetermined processes on the image signals, and then outputs the image signals to the A/D conversion circuit 32. In this instance, if the CCD 20 is operating, the image processing unit 31 uses an adjusted value which is computed based on the output from the CCD 20 by the CPU 39 and which is used for controlling the white balance and the brightness value.

Furthermore, the A/D conversion circuit 32 converts the image signal, i.e., an analog signal, into image data which is a digital signal, and outputs the image data to the DSP 33. The DSP 33 outputs the image data to the frame memory 35 and causes the LCD 6 to display an image corresponding to the image data.

In this manner, CCD 20 operates the electronic shutter with a predetermined time interval when the LCD cover 14 is open, and executes the operation of the electronic viewfinder by converting the signal output from the CCD 20 into image data each time, outputting the image data to the frame memory 35 and continuously displaying the image of the object on the LCD 6.

If the LCD cover 14 is closed as described above, the electronic viewfinder operation is not executed and operation of the CCD 20, the image processing unit 31 and the stop driving circuit 53 are halted to conserve energy.

Shooting images of an object according to an embodiment of the invention will be described next.

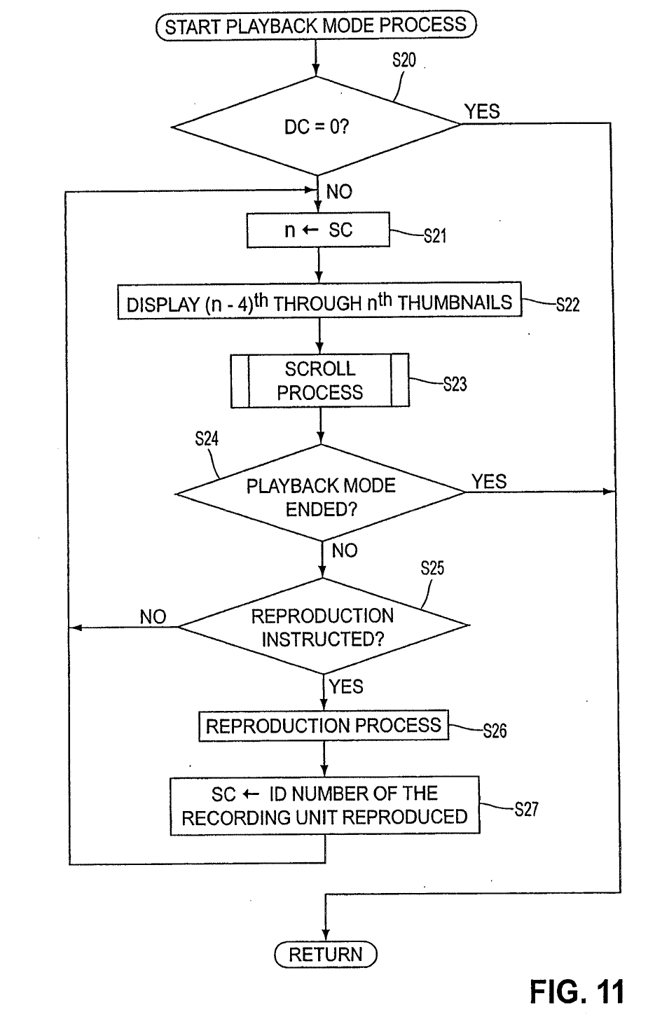

First, switching the continuous shooting mode switch 13 positioned on surface Y1, to the S-mode, i.e., the mode in which only one frame is shot, is explained. Power is introduced to the electronic camera 1 by switching the power source switch 11, shown in FIG. 11, to the “ON” position. The process of shooting an image of the object begins when the release switch 10, positioned on surface Y1, is pressed after verifying the object position with the viewfinder 2.

If the LCD cover 14 is closed, the CPU 39 starts operation of the CCD 20, the image processing unit 31 and the stop driving circuit 53 when the release switch 10 is in the half-depressed status. The process of shooting the image begins when the release switch 10 reaches the fully-depressed status, i.e., the state in which a second control process is executed.

The image of the object observed through the viewfinder 2 is gathered by shooting lens 3 and forms an image on the CCD 20, which includes a plurality of pixels. The photo image imaged on the CCD 20 is photoelectrically converted into an image signal by each pixel and is sampled by the image processing unit 31. The image signal, which is sampled by the image processing unit 31, is supplied to the A/D conversion circuit 32, where it is digitized and output to the DSP 33.

The DSP 33, after outputting the image temporarily to the buffer memory 36, reads the image data from the buffer memory 36, compresses the image data using the JPEG (Joint Photographic Experts Group) standard, which is a combination of a discrete cosine transformation, quantization, and Huffman encoding, and records the image data in the shooting image recording area of the memory card 24. At this time, the shooting date data is recorded as header information of the shooting image data in the shooting image recording area of the memory card 24.

If the continuous shooting mode switch 13 is switched to the S-mode, only one frame is shot and additional shooting does not take place even if the release switch 10 is continued to be pressed. Additionally, if the release switch 10 is continued to be pressed, the image which has been shot is displayed on the LCD when the LCD cover 14 is open.

The case in which the continuous shooting mode switch 13 is switched to the L-mode (a mode in which 8 frames per second are shot continuously) is described as follows. Power is introduced to the electronic camera 1 by switching the power source switch 11 to the “ON” position. The image shooting process begins when the release switch 10 is pressed.

In this instance, if the LCD cover 14 is closed, the CPU 39 starts operation of the CCD 20, the image processing unit 31 and the stop driving circuit 53 when the release switch 10 is in the half-depressed position, and begins the process of shooting the object when the release switch 10 reaches the fully-depressed position.

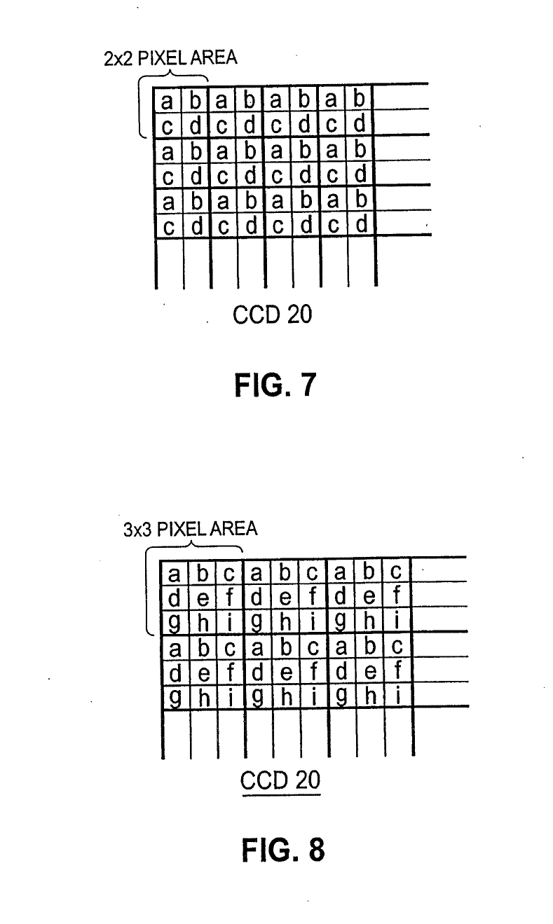

The photo image of the object observed through the viewfinder 2 is gathered by the shooting lens 3 and forms an image on the CCD 20. The photo image which is imaged onto the CCD 20 is photoelectrically converted into an image signal by each pixel, and is sampled by the image processing unit 31 at a rate of 8 times per second. The image processing unit 31 thins out three-fourths of the pixels of the image signals of all of the pixels in the CCD 20. In other words, the image processing unit 31 divides the pixels in the CCD 20 into areas of 2×2 pixels (4 pixels) as shown in FIG. 7, and samples the image signal of one pixel arranged at a predetermined location from each area, thinning out the remaining 3 pixels.

For example, during the first sampling, i.e., first frame, the pixel a located on the left upper corner is sampled and other pixels b, c and d are thinned out. During the second sampling, i.e., second frame, the pixel b located on the right upper corner is sampled and the other pixels a, c and d are thinned out. Likewise, during the third and the fourth sampling, the pixels c and d which are respectively located at the left lower corner and the right corner are sampled and the rest are thinned out. In short, each pixel is sampled once during four samplings.

The image signals (image signals of one-fourth of all the pixels in the CCD 20) that are sampled by the image processing unit 31 are supplied to the A/D conversion circuit 32 where they are digitized and output to the DSP 33.

The DSP 33, after outputting the image temporarily to the buffer memory 36, reads the image data from the buffer memory 36, compresses the image data using the JPEG method, and records the digitized and compressed shooting image data in the shooting image recording area of the memory card 24. At this time, the shooting date data is recorded as header information of the shooting image data in the shooting image recording area of the memory card 24.

Next, the case in which the continuous shooting mode switch 13 is switched to the H-mode, i.e., a mode in which 30 frames are shot per second, is described. Power is introduced to the electronic camera 1 by switching the power source switch 11 to the “ON” position. The process of shooting the object begins when the release switch 10 is pressed.

In this instance, if the LCD cover 14 is closed, the CPU 39 starts operation of the CCD 20, the image processing unit 31 and the stop driving circuit 53 when the release switch 10 is in the half-depressed position, and begins the process of shooting the object when the release switch 10 reaches the fully-depressed position.

The light image of the object is observed through the viewfinder 2 is gathered by the shooting lens 3 and is imaged on the CCD 20. The light image of the object imaged on the CCD 20 is photoelectrically converted to an image signal by each pixel and is sampled 30 times per second by the image processing unit 31. At this time, the image processing unit 31 thins out eight-ninths of the pixels in the image electric signals of all of the pixels in the CCD 20.

In other words, the image processing unit 31 divides the pixels in the CCD 20, which are arranged in a matrix into areas comprising 3×3 pixels (9 pixels) as shown in FIG. 8, and samples, at a rate of 30 times per second, the image signal of one pixel which is arranged in a predetermined position in each area. The remaining 8 pixels are thinned out.

For example, during the first sampling, i.e., first frame, the pixel a located on the left upper corner of each area is sampled and the other pixels b through i are thinned out. During the second sampling, i.e., second frame, the pixel b, located on the right corner is sampled and the other pixels, a, and c through i are thinned out. Likewise, during the third and the fourth samplings, etc., the pixel c and the pixel d, etc. are sampled, respectively, and the rest are thinned out. In short, each pixel is sampled once for every nine frames.

The image signals, i.e., image signals of one-ninth of all the pixels in the CCD 20 that are sampled by the image processing unit 31 are supplied to the A/D conversion circuit 32 where they are digitized and are output to the DSP 33. The DSP 33, after outputting the image temporarily to the buffer memory 36, reads the image data, compresses the image data using the JPEG method, and records the digitized and compressed shooting image data in the shooting image recording area of the memory card 24.

In this instance, light may be shined on the object, if necessary, by operating the strobe 4. However, when the LCD cover 14 is open, or when the LCD 6 executes the electronic viewfinder operation, the CPU 39 controls the strobe 4, preventing it from emitting light.

Next, an operation in which two dimensional information, i.e., memo information is input from the touch tablet 6A is described.

When the touch tablet 6A is pressed by the tip of the pen 41, the X-Y coordinate of the contact point is supplied to the CPU 39. The X-Y coordinate is stored in the buffer memory 36. Moreover, the CPU 39 writes data of the address in the frame memory 35, which corresponds to each X-Y coordinate point, and the line drawing corresponding to the contact point of the pen 41 is displayed on the LCD 6.

As described above, the touch tablet 6A is made of transparent material and the user is able to view the point, i.e., the point of the location being pressed by the tip of the pen 41 being displayed on the LCD 6, which gives an impression that the input is made by the pen directly onto the LCD 6. When the pen 41 is moved on the touch tablet 6A, a line tracing the motion of the pen 41 is displayed on the LCD 6. If the pen 41 is moved intermittently on the touch tablet 6A, a dotted line tracing the motion of the pen 41 is displayed on the LCD 6. In this manner, the user is able to input line drawing information of desired letters and drawings to the touch tablet 6A.

If the line drawing information is input by the pen 41 when the shooting image is already displayed on the LCD 6, the line drawing information is synthesized (combined) with the shooting image information by the frame memory 35 and both are displayed together on the LCD 6. By operating a predetermined palette (not shown), the user is able to choose the color of the line drawing to be displayed on the LCD 6 from black, white, red, blue and other colors.

If the execution key 7B is pressed after the line drawing information is input to the touch tablet 6A by the pen 41, the line drawing information accumulated in the buffer memory 36 is supplied with header information of the input date to the memory card 24 and is recorded in the line drawing information recording area of the memory card 24.

In this instance, the line drawing information recorded in the memory card 24 includes compressed information. The line drawing information input in touch tablet 6A contains information with high spatial frequency components. Hence, if the aforementioned JPEG method is used to compress the line drawing information, compression efficiency becomes poor and the amount of information is not reduced, resulting in a longer time for compression and decompression. Moreover, compression by means of the JPEG method is lossey. Hence, it is not suitable for the compression of line drawing information, which has a small amount of information. This is because gather and smear effects due to missing information become noticeable when the information is decompressed and displayed on the LCD 6.

Hence, according to an embodiment of the invention, line drawing information is compressed using the run length method used in facsimile machines and similar devices. The run length method is a method in which the line drawing screen is scanned in a horizontal direction and the line drawing information is compressed by encoding each continuous length of information of each color such as black, white, red and blue as well as each continuous length of non-information, i.e., where there is no pen input.

Using the run length method, line drawing information is compressed to minimize the amount of information that is lost when the compressed line drawing information is decompressed. Moreover, it is possible to forego compression of the line drawing information if the amount of information is relatively small.

As mentioned above, if line drawing information is input by the pen when the shooting image is already displayed on the LCD 6, the pen input is synthesized with the shooting image information by the frame memory 35 and the synthesized image of the shooting image and a line drawing is displayed on the LCD 6. Also, the shooting image data is recorded in the shooting image recording area and the line drawing information is recorded in the line drawing information recording area of the memory card 24. In this manner, two types of information are recorded separately. Hence, the user may be able to delete one of the two images, i.e., line drawing from the synthesized image of the shooting image and the line drawing. Additionally, further compression of each type of image information by means of a separate compression method is possible.

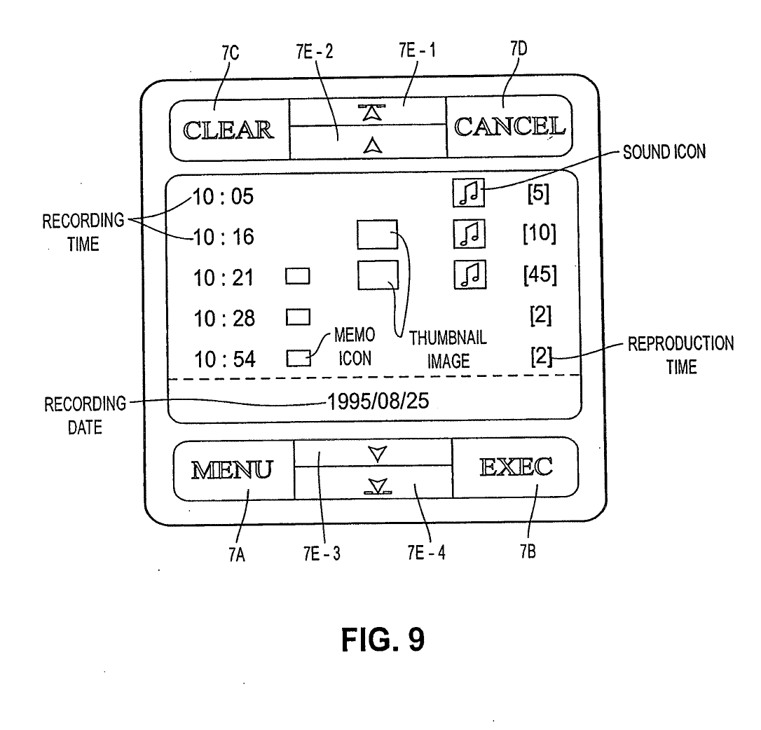

When data is recorded in the sound recording area, the shooting image recording area and/or the line drawing information recording area of memory card 24, recorded information may be reproduced in the playback mode. If the playback mode is selected from the menu being displayed by pressing of menu key 7A and the playback mode is enabled, a table of information recorded in the memory card 24 is displayed on the LCD 6, as shown in FIG. 9.

As shown in FIG. 9, the date of recording information, i.e., recording date, Aug. 25, 1995 in this case, is displayed on the bottom section of the LCD display screen. The recording time of the information recorded on that recording date is displayed to the left-most side of the LCD display screen. A separate recording time is displayed for each recording unit. Each recording unit can have one or more of shooting image data, line drawing information and sound information. A memo icon, which is displayed to the right of the recording time, indicates that a predetermined memo is recorded as line drawing information for that particular recording time. To the right of the memo icon, a thumbnail image is displayed when shooting image data is present. The thumbnail image is formed by thinning out, i.e., reducing, the bit map data of image data of the shooting image data recorded in the memory card 24. In the present example, information recorded, i.e., input, at “10:16” and “10:21” contains shooting image information, but information recorded at “10:05”, “10:28” and “10:54” does not contain image information.

A sound icon displayed on the right of the thumbnail image indicates that the sound is recorded for a recording unit. Reproduction times of various information are also displayed to the right of the sound icon. For example, the reproduction time of the sound in the first line is five seconds.

The contents of the display on the screen shown in FIG. 9 are changed as needed when the scroll key 7E (7E-1 through 7E-4) is operated or when information is recorded as will be described later.

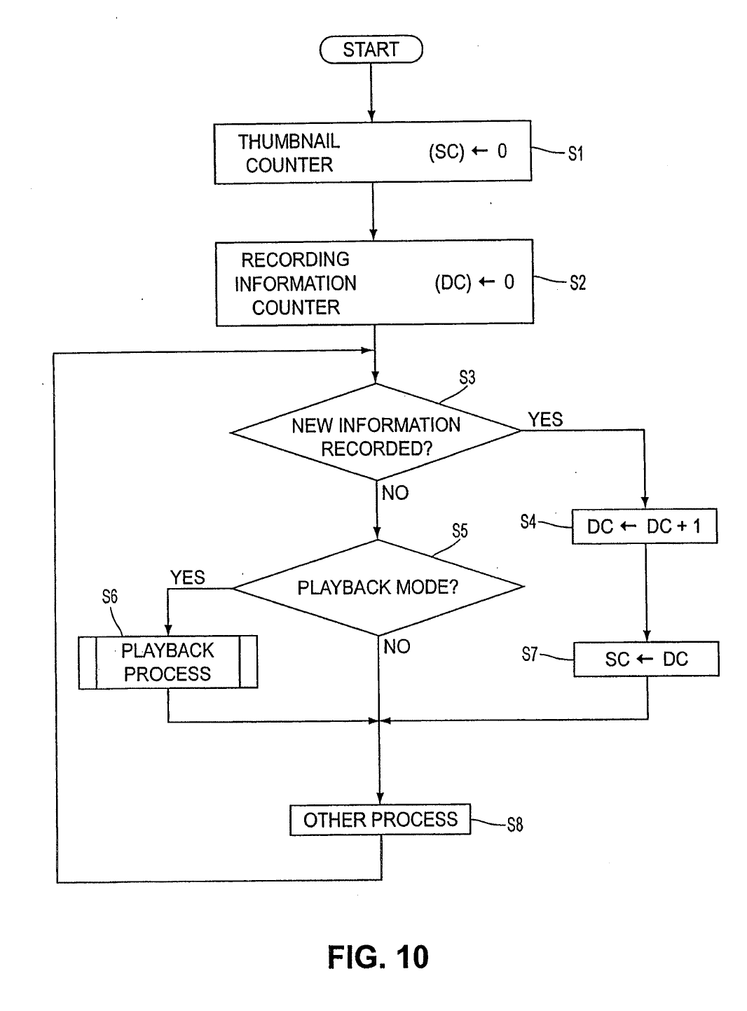

The user selects and designates information to be reproduced by pressing, with the tip of the pen 41, any part of the desired information displayed on the LCD 6, as shown in FIG. 10. The selected information is reproduced by pressing, with the tip of the pen 41, the execution key 7B as shown in FIG. 2.

For example, if the sound icon at “10:05” shown in FIG. 9 is pressed by the pen 41, the CPU 39 reads the sound data corresponding to the selected recording date (10:05) from the memory card 24, decompresses the sound data, and then supplies the sound data to the A/D and D/A conversion circuit 42. The A/D and D/A conversion circuit 42 converts the data to analog signals, and then reproduces the sound through the speaker 5.

In reproducing the shooting image data recorded in the memory card 24, the user selects the information by pressing the desired thumbnail image with the tip of the pen 41, then reproduces the selected information by pressing the execution key 7B.

In other words, the CPU 39 instructs the DSP 33 to read the shooting image data corresponding to the selected image shooting date and time from the memory card 24. The DSP 33 decompresses the shooting image data, i.e., compressed shooting data, which is read from the memory card 24 and accumulates the shooting image data as bit map data in the frame memory 35, which then is displayed on the LCD 6.

The image which is shot in the S-mode is displayed as a still image on the LCD 6. This still image is obviously the image reproduced from the image signals of all the pixels in the CCD 20.

The image which is shot in the L-mode is continuously displayed (i.e., as a moving picture) at 8 frames per second on the LCD 6. In this case, the number of pixels displayed in each frame includes one-fourth of all of the pixels in the CCD 20. Human vision is sensitive to the deterioration of still image resolution. Hence users can easily detect the thinning out of the pixels in the still image. However, the shooting speed is increased in the L-mode where the images of 8 frames are reproduced per second. Thus, even though the number of pixels in each frame becomes one-fourth of the number of pixels of the CCD 20, the information amount per unit of time doubles compared to the still image because the human eyes observe images of 8 frames per second.

In other words, assuming the number of pixels of one frame of the image which is shot in the S-mode to be one, the number of pixels in one frame of the image which is shot in the L-mode becomes one-fourth. When the image, i.e., still image, which is shot in the S-mode is displayed on the LCD 6, the amount of information viewed by a human eye per second is 1(=(number of pixels 1)×(number of frames 1)). On the other hand, when an image which is shot in the L-mode is displayed on the LCD 6, the amount of information viewed by a human eye per second is 2(=(number of pixels ¼)×(number of frames 8)). Therefore, twice as much information is viewed by a human eye. Hence, even when the number of pixels in one frame is reduced to one-fourth, the user does not notice much deterioration of the image quality during reproduction.

According to an embodiment of the invention, different sampling is executed (i.e., a different pixel is sampled) for each frame and the sampled pixels are displayed on the LCD 6. Hence, after image effects occur on the human eye, and the user can view the image which is shot in the L-mode and which is displayed on the LCD 6 without noticing deterioration of the image even when three-fourths of the pixels are thinned out per one frame.

The image shot in the H-mode is displayed on the LCD 6 at 30 frames per second. At this time, the number of pixels displayed in each frame is one-ninth of the total number of the pixels of the CCD 20. However, the user can view the image shot in the H-mode and displayed on the LCD 6 without noticing much deterioration of image quality for the same reasons as in the case of the L-mode.

According to an embodiment of the invention, when the object is shot in the L-mode or H-mode, because the image processing unit 31 is made to thin out the pixels in the CCD 20 in such a manner that the user does not notice deterioration of the image quality during reproduction, the load on the DSP 33 and the decompression process unit 34 is reduced, enabling the low speed and low power operation of these units. Moreover, a low cost and low energy consumption operation of the apparatus may be achieved.

In a configuration of the invention, the contents of the display of a table, i.e., a table of information recorded in the memory card 24, which is displayed during a playback mode may be changed when the scroll key 7E is operated and recording or reproduction of information are being executed. This process is described hereafter.

FIG. 10 shows an example of a process executed according to an embodiment of the invention. This process is executed when the power source of the electric camera 1 is turned on for the first time.

In step S1, the CPU 39 initializes and substitutes 0 for the variable SC, i.e., the thumbnail counter. The value assigned to the variable SC is the ID number (to be explained later) of the last information that is displayed in the table that is displayed when the playback mode is enabled.

In step S2, the CPU 39 initializes and substitutes 0 for the variable DC, which is the recording information counter. The value assigned to the variable DC is the ID number of the last information recorded in the memory card 24.

In this instance, the ID number is created in ascending order from 1 by incrementing the variables by 1 each time information is recorded. When a plurality of different types of information is recorded simultaneously, only one ID number is assigned for that plurality of different types of information. Hence, if the different types of information includes a shooting image and sound, as displayed in the second row in FIG. 9, only one ID number is given to these two types of information. Hereafter, such simultaneously recorded information to which the same ID number is given will be referred to as a recording unit. (It is also possible to assign the same ID number to information recorded at different times. This would occur, for example, when information in a particular recording unit is edited after it is initially recorded.)

In the next step S3, the CPU 39 determines whether or not a new recording unit (information) is recorded. As a result, if new information is determined to have been recorded (YES), the CPU 39 moves to step S4. If new information is determined not to have been recorded (NO), the CPU 39 moves to step S5.

In step S4, the CPU 39 increments the value of variable DC by 1, indicating that a new recording unit has been recorded. Then the CPU 39 moves to step S7, substitutes the value of variable DC into the variable SC, and moves to step S8.

On the other hand, if a new recording unit is determined not to have been recorded (NO) in step S3, the CPU moves to step S5. In step S5, the CPU 39 determines whether or not the playback mode has been selected. As a result, if the playback mode is determined to have been selected (YES), the CPU 30 moves to step S6, executes a subroutine for the playback mode process, and moves to step S8. If the playback mode is determined not to have been selected (NO), the CPU 39 moves to step S8.

In step S8, another process, for example, a process to check input from an input device such as a touch tablet 6A, is executed. Then, the CPU 39 returns to step S3 and repeats the same processes as in the previous case.

FIG. 11 is a flow chart showing the playback mode process of step S6, shown in FIG. 10 in greater detail. This process is called and executed when the process of step S6 is executed. When this process is called, in step S20 the CPU 39 determines whether or not the value of the variable DC is 0. As a result, if the value of the variable DC is determined to be 0 (YES), the CPU 39 returns to step S8 in FIG. 10. If the value of variable DC is determined not to be 0 (NO), the CPU 39 moves to step S21.

In step S21, the value of the variable SC is substituted for the variable n. Then, the CPU 39 executes step S22, whereby the CPU 39: (a) reads from the memory card 24 the recording units with ID numbers from (n−4) through n; and (b) creates a table by displaying time of recording and the types of information contained and reproduction time of the identified recording units in the LCD 6. Flow then moves to step S23.

In step S23, the scroll process is executed. The scroll process is executed according to operation of the scroll key 7E. In this instance, this process includes a subroutine, the details of which will be described later.

In step S24, the CPU 39 determines whether or not the indication to end the playback mode is made by a predetermined operation. As a result, if the indication to end the playback mode is determined to be YES, the CPU 39 returns to step S8 in FIG. 10. If the indication to end the playback mode is determined to be NO, the CPU 39 moves to step S25.

At step S25, the CPU 39 determines whether or not an indication to reproduce a selected recording unit is made. In other words, the CPU 39 determines whether or not the execution key 7B is pressed after an item is selected by the pen 41 from the display items being displayed in the LCD 6. As a result, if the indication to reproduce is determined not to have been made (NO), the CPU 39 returns to step S21 and repeats the same process as in the previous instance. If the indication to reproduce the predetermined recording unit is determined to have been made (YES), the CPU 39 moves to step S26.

In step S26, the reproduction process of the recording unit indicated in step S25 is executed. The CPU 39 reads from the memory card 24 information contained in the designated recording unit, supplies the information to the DSP 33 and/or to A/D and D/A converter circuit 42, and reproduces the image and/or sound.

In step S27, the ID number of the recording unit reproduced in step S26 is substituted into the variable SC. Then, the CPU 39 returns to step S21 and repeats the same process as in the previous instance.

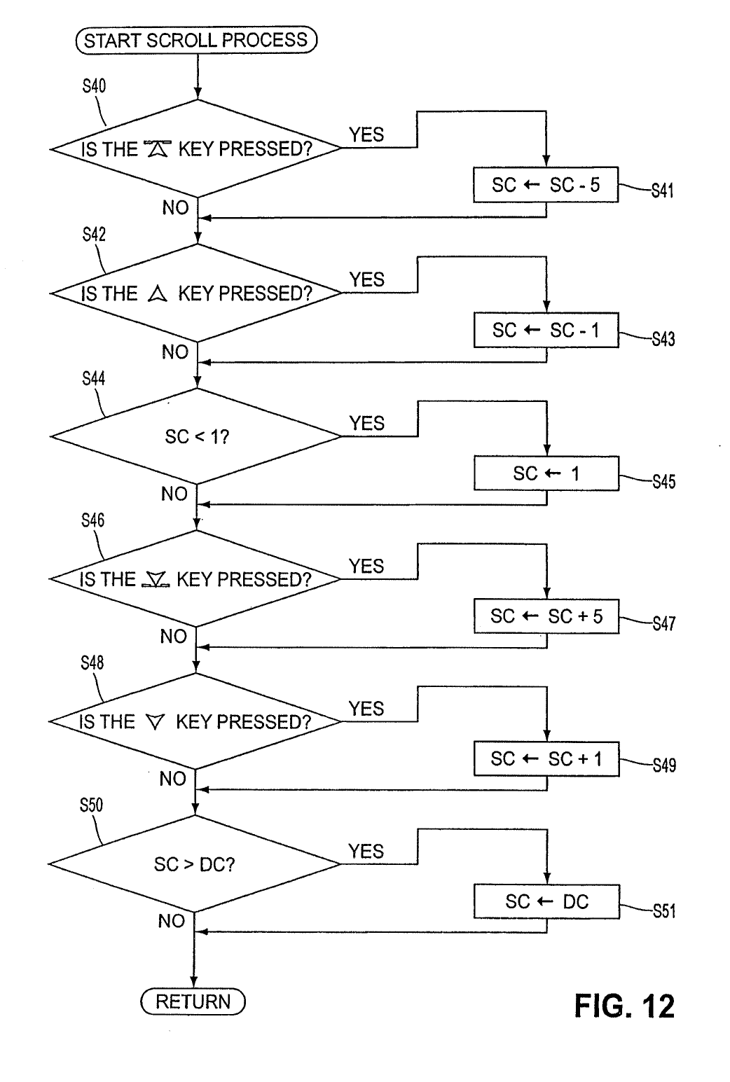

FIG. 12 is a flow chart showing the details of the scroll process of step S23 shown in FIG. 11. This process is called and executed when the process of step S23 is executed.

Before describing the process shown in FIG. 12, an explanation of the scroll key 7E is provided. The scroll key 7E is provided above and below the central section of the LCD 6, shown in FIG. 9, and is composed of the scroll keys 7E-1 through 7E-4. The scroll keys 7E-1 and 7E-4 are the keys used to scroll the screen upwards and downwards by one page (e.g., five lines at a time) respectively. The scroll keys 7E-2 and 7E-3 are used to scroll the screen upwards and downwards one line at a time.

When the FIG. 12 process is called, in step S40, the CPU 39 determines whether or not the scroll key 7E-1 (the key provided at the uppermost part above the center of the LCD 6) is pressed. As a result, if the scroll key 7E-1 is determined to have been pressed (YES), the CPU 39 moves to step S41, reduces the value of the variable SC by 5, and moves to step S42. On the other hand, if the scroll key 7E-1 is determined not to have been pressed (NO), the CPU 39 moves to step S42.

In step S42, the CPU 39 determines whether or not the scroll 7E-2, i.e., the key positioned second from the top above the center of the LCD 6, is pressed. As a result, if the scroll key 7E-2 is determined to have been pressed (YES), the CPU 39 moves to step S44, reduces the value of the variable SC by 1, and moves to step S44. On the other hand, if the scroll key 7E-2 is determined not to have been pressed (NO), the CPU 39 moves to step S44.

In step S44, the CPU 39 determines whether or not the value of the variable SC is less than 1. As a result, if the value of the variable SC is determined to be less than 1 (YES), the CPU 39 moves to step S45 and the value 1 is substituted into the variable SC. In other words, since the minimum value of the ID number of the recording unit is 1, if the value of the variable SC becomes less than 1, the CPU 39 resets the value to be 1 again. On the other hand, if the value of the variable SC is determined to be 1 or larger (NO), the CPU 39 moves to step S46.

In step S46, the CPU 39 determines whether or not the scroll key 7E-4, i.e., the key positioned at the lowermost part below the center of the LCD 6, is pressed. As a result, if the scroll key 7E-4 is determined to have been pressed (YES), the CPU 39 moves to step S47, increases the value of the variable SC by 5, and moves to step S48. On the other hand, if the scroll key 7E-4 is determined not to have been pressed (NO), the CPU 39 moves to step S48.

In step S48, the CPU 39 determines whether or not the scroll key 7E-3, i.e., the key positioned at the second to the lowermost part below the center of the LCD 6, is pressed. As a result, if the scroll key 7E-3 is determined to have been pressed (YES), the CPU 39 moves to step S49, increases the value of the variable SC by 1, and moves to step S50. On the other hand, if the scroll key 7E-3 is determined not to have been pressed (NO), the CPU 39 moves to step S50.

In step S50, the CPU 39 determines whether or not the value of the variable SC is greater than the value of the variable DC. If the value of the variable SC is determined to be greater than the value of the variable DC (YES), the CPU 39 moves to step S51, substitutes the value of the variable DC into the variable SC, and returns to the process of step S24 in FIG. 11. In other words, if the value of the variable SC becomes larger than the maximum value (=DC) of the ID number of the recording unit, the value of the variable SC is reset to the value of the variable DC. On the other hand, if the value of the variable SC is determined to be less than or equal to the value of the variable DC (NO), the CPU returns to the process of step S24 in FIG. 11.

The above process is described in greater detail hereafter, with reference to FIGS. 9, 13 and 14.

Now suppose that a plurality of information is recorded in the memory card 24 of the electronic camera 1. In other words, the electronic camera 1 is in a state wherein a plurality of information is recorded after execution of the process steps S1 and S2.

Under these conditions, if a predetermined input is executed to select the playback mode, for example, menu key 7A is pressed and the playback mode is selected from the menu being displayed. Then if the decision made in step S5 of the process shown in FIG. 10 is determined to have been YES, the CPU 39 moves to step S6.

Upon execution of a subroutine at step S6, the process of step S20 shown in FIG. 11 is called. At step S20, the value of the variable DC, i.e., the variable which stores the number of recording units being recorded in the memory card 24 is not 0. Hence, the decision made in step S20 is determined to have been NO, and CPU 39 moves to step S21. At step S21, the value of the variable SC is substituted for the variable n. Now, suppose SC=DC, and DC=20, i.e., 20 recording units are recorded, then the value 20 is substituted for the variable n.

At step S22, information relating to recording units from 16th (=20−4) through 20th (=n) (recording date and time, type of information and reproduction time) are displayed on the LCD 6. Now suppose that the display shown in FIG. 9 is displayed as a result of the process of step S22.

At step S23, a scroll process is executed. In other words, the process described in FIG. 12 is executed. When scroll key 7E-2, i.e., the key positioned at the second from the top, above the central section of the LCD 6, is pressed, the decision from process step S42 is determined to be YES and the value of the variable SC is decremented by 1. Since no other keys are operated, the subsequent decision process is determined to be NO, and the CPU 39 returns to step S24.

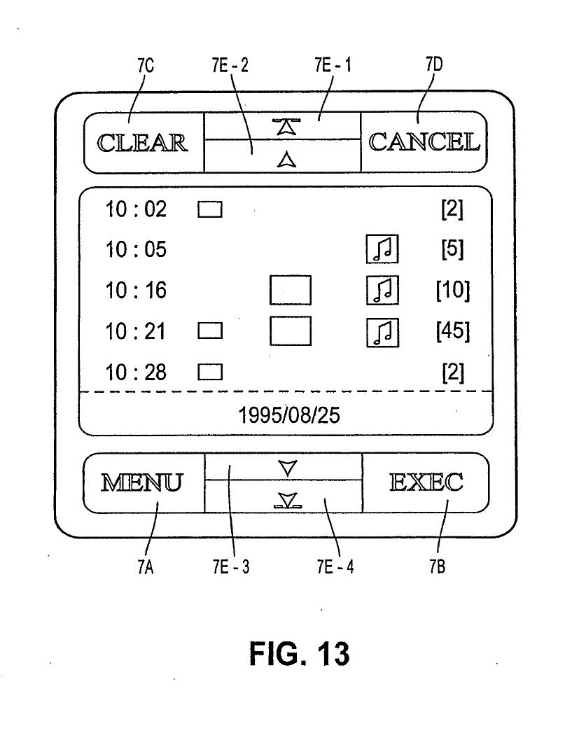

In this instance, since no other keys are operated, the decisions made at step S24 and step S25 are determined to be NO, and the CPU 39 returns to the process of step S21. In step S21, the value of the variable SC, which is decremented by 1, is substituted for the variable n, and a table relating to recording units from 15th (=19−4) through 19th (=n) is displayed as shown in FIG. 13 at the following step S13. In FIG. 13, information “10:28”, which is displayed second from the bottom in FIG. 9, is displayed on the bottom, indicating that the screen is scrolled upwards by one line due to operation of the scroll key 7E-2.

When other scroll keys 7E-1, 7E-3 and 7E-4 are operated, the value of the variable SC is increased or decreased appropriately, which scrolls the screen accordingly in the predetermined direction by a predetermined amount.

Referring to the display screen shown in FIG. 13, if, for example, a predetermined operation is selected from the menu which is displayed as a result of operation of the menu key 7A, then the decision at step S24 is determined to be YES and the CPU 39 returns to step S8 shown in FIG. 10. In step S8, the process corresponding to the item selected, i.e., the other process, is executed.

If the playback mode is selected again after the execution of a predetermined process, i.e., a process other than recording of information by the selection of a predetermined item, then the decision made in step S5 is determined to be YES and the playback mode process shown in FIG. 11 is executed. In this case, the value of the variable SC is not changed, hence, in step S21, the value 19 is substituted for the variable n. In step S22, a table listing the 15th through 19th recording units are displayed. This display screen is the same as the display screen shown in FIG. 13 that is displayed when ending the previous playback mode.

The process of reproducing predetermined information during the playback mode will hereinafter be described.

As described earlier, the playback mode process shown in FIG. 11 can be executed and the screen shown in FIG. 9 can be displayed. Under these conditions, if, for example, the execution key 7B is pressed after selection of the recording unit by pen 41 (the recording unit which is recorded at 10:28) then the decision at step S25 is determined to have been YES and the designated information will be reproduced at step S26. The recording unit is displayed second from the bottom on the screen.

Upon completing reproduction of the designated information, the CPU 39 moves to step S27 and the ID number (=19) of the reproduced recording unit is substituted for the variable n. The CPU 39 then moves to step S21. In step S21, the value 19, which is the value of the variable SC, is substituted for the variable n, and tables corresponding to 15th through 19th recording units are displayed in step S22. In other words, the display is executed with the reproduced recording unit placed at the bottom.

Reproduced information may be displayed at the top of the display. Information immediately before and after may be displayed excluding the reproduced information.

The process by which information is newly recorded will hereinafter be described.

Assume that a total of 20 recording units are recorded in the memory card 24, with the recording unit at “10:54” being the last information, as shown in FIG. 9. Under these conditions, if a new recording unit is recorded, then the decision in step S3 of FIG. 10 is determined to be YES, and the value of the variable DC is incremented by 1 to 21 at step S4. In step S7, the value of the variable DC is substituted into the variable SC. If another new recording unit is recorded later, the same process previously executed will be repeated, changing the values of the variable SC and the variable DC to both be 22.

If the playback mode is selected after completion of shooting, the decision in step S5 is determined to have been YES and the playback mode process shown in FIG. 11 is executed.

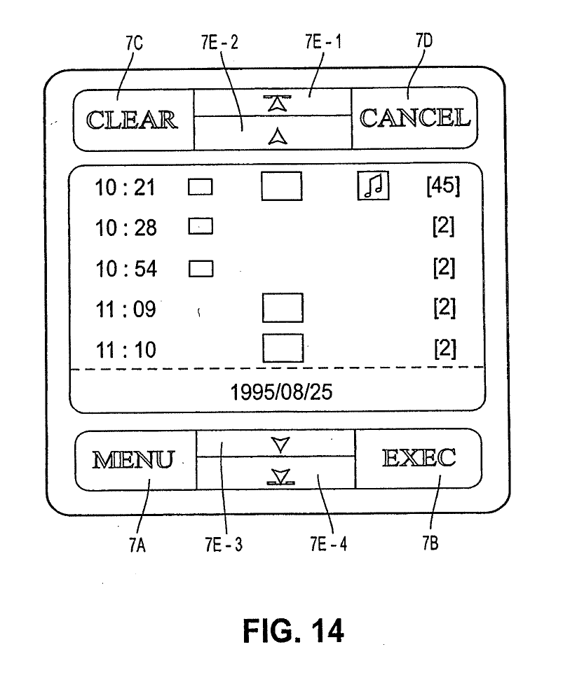

In step S21, the value 22, which is the value of the variable SC, is substituted into the variable n. Then, in step S22, the table listing the 18th (=22−4) through 22nd recording units will be displayed, as shown in FIG. 14. In this Figure, information related to the recording units which are newly recorded at “11:09” and “11:10” are displayed at the bottom of the screen. In other words, if a new recording unit is recorded, a screen display will be executed in such a manner that the information which is recorded last (most recently) is displayed on the lowermost line of the screen. If six or more new pieces of information are recorded, information which is recorded first may be displayed at the top of the screen.

According to the embodiment of the invention described above, a screen which is the same as the previous screen will be displayed if the playback mode is selected for the second time. In other words, if the screen is scrolled, the screen displayed immediately before the playback mode will be displayed again. Hence, in a situation when another process is executed due to urgent need during the operation of the playback mode and the operation is continued by returning again to the playback mode, the previous display is displayed again. Hence, trouble free operation is achieved.

If a predetermined recording unit is reproduced during the playback mode, the screen is re-displayed in such a manner that the reproduced recording unit is displayed at the lowermost line of the screen. Thus, it becomes possible to select other information accurately using as a guide the recording unit displayed at the lowermost line. In the situation where reproduced information is displayed at the uppermost line of the screen, information selection becomes easy for reproducing the recording unit in time series.

If new information is recorded, the screen display is executed in such a manner that the information recorded last is placed at the lowermost line in the screen. Hence, in confirming the recorded information, the newest information is displayed on the lowermost line of the screen, and immediate reproduction of desired information becomes possible.

The scope of the invention is not limited to the embodiments of the electronic camera described above, and the invention may be applied to other information processing apparatus.

Although the JPEG and run length encoding compression techniques were described, other compression techniques (or no compression at all) can be used with the invention.

Although a touch tablet with input pen were described as structures through which selections and commands can be input, the invention is not limited to such structure. For example, the touch tablet can be actuable by the user's finger. Additionally, selections and commands can be input without using a touch tablet. For example, a cursor can be moved (e.g., via a mouse) and selections or commands can be made by clicking.

The invention is not limited to implementation by a programmed general purpose computer as shown in the preferred embodiment. For example, the invention can be implemented using one or more special purpose integrated circuit(s) (e.g., ASIC). It will be appreciated by those skilled in the art that the invention can also be implemented using one or more dedicated or programmable integrated or other electronic circuits or devices (e.g., hardwired electronic or logic circuits such as discrete element circuits, or programmable logic devices such as PLDs, PLAs, PALs or the like). In general, any device or assembly of devices on which a finite state machine capable of implementing the flow charts shown in FIGS. 10-12 can be used.

While this invention has been described in conjunction with specific embodiments thereof, it is evident that many alternatives, modifications and variations will be apparent to those skilled in the art. Accordingly, the preferred embodiments of the invention set forth herein are intended to be illustrative, not limiting. Various changes may be made without departing from the spirit and scope of the invention as defined in the following claims.

What is claimed is:

1. An information displaying apparatus that processes recording units that include at least one of image information, memo information and sound information, comprising:
storage means for storing the recording units;
table creation means for creating a table listing the recording units stored in the storage means;
displaying means for displaying a portion of the table, the portion of the table includes an icon corresponding to the recording units stored in the storage means on the table, and the portion of the table corresponds to a predetermined number of recording units that is smaller than a total number of recording units that can be stored on the storage means;
second storage means for storing information indicating the portion of the table that was displayed when the table was last output for display;
input means for being operated when the table created by the table creation means is displayed;
detection means for detecting a recording unit stored in the storage means since the table was last output for display;
output means for automatically switching, based on whether the detection means has detected the recording unit stored since the table was last output for display when a predetermined input is performed by the input means, between: (i) the portion of the table which contains information regarding the recording units for display when the detection means detects the recording unit that was stored since the table was last displayed, and (ii) the portion of the table corresponding to the information stored in the second storage means when the detection means does not detect the recording unit that was stored since the table was last displayed, wherein (i) and (ii) are each a displayable area of the table; and
scroll input means for inputting a scroll command, wherein
the scroll input means is provided with a first scroll means that scrolls a recording unit of the recording units and a second scroll means that scrolls a plurality of recording units of the recording units, through operation of the scroll input means,
the displaying means updates a display of a specified portion of the list according to the operation of the first and second scroll means, and
the second storage means stores information regarding the portion of the table that was output for display when the scroll input means was operated to scroll the table.

2. The information displaying apparatus according to claim 1, further comprising:
designation means for designating a predetermined recording unit from the portion of the table that is displayed; and
reproduction means for reproducing the information of the recording unit designated by the designation means, wherein
the output means outputs the portion of the table listing the recording unit designated by the designation means after reproduction of the recording unit designated by the designation means by the reproduction means.

3. The information displaying apparatus according to claim 1, further comprising:
designation means for designating a predetermined recording unit from the portion of the table that is displayed; and
reproduction means for reproducing the information of the recording unit designated by the designation means, wherein
the output means outputs a portion of the table containing recording units stored either before or after the recording unit designated by the designation means after reproduction of the recording unit designated by the designation means by the reproduction means.

4. The information displaying apparatus according to claim 1, further comprising:
input means for inputting said predetermined input signal.

5. The information displaying apparatus according to claim 1, wherein said image information is bit-map data of a photographed object.

6. The information displaying apparatus according to claim 1, wherein said memo information is bit-map data of a line drawing.

7. The information displaying apparatus according to claim 1, wherein said apparatus is an electronic camera that further comprises:
means for photographing an object to input bit-map data of the object as said image information; and
means for inputting line drawing information as said memo information.

8. The information displaying apparatus according to claim 7, further comprising:
a microphone through which said sound information is input.

9. An information displaying apparatus that processes recording units that include at least one of image information, memo information and sound information, comprising:
a memory that stores the recording units;
a table generator that creates a table listing the recording units stored in the memory;
a display that displays a portion of the table, the portion of the table includes an icon corresponding to the recording units stored in the memory on the table, and the portion of the table corresponds to a predetermined number of recording units that is smaller than a total number of recording units that can be stored on the memory;
a second memory that stores information indicating the portion of the table that was displayed when the table was last output for display;
an input device for being operated when the table created by the table generator is displayed;
a controller coupled to the memory, the second memory and to the table generator, the controller automatically switches, based on whether a recording unit has been stored since the table was last output for display when a predetermined input is performed by the input device, between: (i) the portion of the table which includes information regarding stored recording units that are stored in the memory since the table was last displayed, when the controller detects that the recording unit that has been stored since the table was last output for display exists when the predetermined input signal is received, and (ii) the portion of the table corresponding to the information stored in the second memory when the controller does not detect the recording unit that has been stored since the table was last output for display exists when the predetermined input signal is received, wherein (i) and (ii) are each a displayable area of the table; and
scroll input for inputting a scroll command, wherein
the scroll input is provided with a first scroll that scrolls a recording unit of the recording units and a second scroll that scrolls a plurality of recording units of the recording units, through operation of the scroll input,
the display updates a display of a specified portion of the list according to the operation of the first and second scroll, and
the second memory stores information regarding the portion of the table that was output for display when the scroll input was operated to scroll the table.

10. The information displaying apparatus according to claim 9, further comprising:
a scroll input device that inputs a scroll command;
wherein the second memory stores information regarding the portion of the table that was output for display when the scroll input device commands scrolling of the table.

11. The information displaying apparatus according to claim 9, further comprising:
a designation device that designates a predetermined recording unit from the portion of the table that is displayed; and wherein
the controller causes the recording unit that is designated by the designation device to be reproduced and then causes the portion of the table listing the recording unit designated by the designation device to be displayed after reproduction of the recording unit designated by the designation device.

12. The information displaying apparatus according to claim 9, further comprising:
a designation device that designates a predetermined recording unit from the portion of the table that is displayed; and wherein
the controller causes the recording unit that is designated by the designation device to be reproduced and then causes the portion of the table containing recording units stored either before or after the recording unit designated by the designation device to be displayed after reproduction of the recording unit designated by the designation device.

13. The information displaying apparatus according to claim 9, further comprising:
a user-operable member by which the user inputs said predetermined input signal.

14. The information displaying apparatus according to claim 9, wherein said image information is bit-map data of a photographed object.

15. The information displaying apparatus according to claim 9, wherein said memo information is bit-map data of a line drawing.

16. The information displaying apparatus according to claim 9, wherein said apparatus is an electronic camera that further comprises:
a photoelectric converter that inputs bit-map data of an object as said image information; and
a touch tablet that inputs line drawing information as said memo information.

17. The information displaying apparatus of claim 16, further comprising:
a microphone through which said sound information is input.

18. A method of displaying recording units that include at least one of image information, memo information and sound information, comprising the steps of:
storing the recording units;
creating a table listing the recording units;
displaying a portion of the table, the portion of the table including an icon corresponding to the recording units on the table, and the portion of the table corresponding to a predetermined number of recording units that is smaller than a total number of recording units that can be stored;
storing the portion of the table that was displayed when the table was last output for display;
receiving a predetermined input when the table is displayed;
detecting when a recording unit has been stored since the table was last output for display; and
automatically switching, based on whether the recording unit that has been stored since the table was last output for display is detected, when the predetermined input is received in the receiving step, between: (i) the portion of the table which includes information regarding the recording units when storing of the recording unit since the table was last displayed is detected, and (ii) the portion of the table corresponding to the stored information related to the portion of the table that was displayed when the table was last output for display when storing of the recording unit since the table was last displayed is not detected, wherein (i) and (ii) are each a displayable area of the table;
inputting a scroll command, wherein
the inputting of the scroll command includes a first scroll that scrolls a recording unit of the recording units and a second scroll that scrolls a plurality of recording units of the recording units,
the displaying updates a display of a specified portion of the list according to the operation of the first and second scrolls, and
the storing stores information regarding the portion of the table that was output for display when the inputting of the scroll command was operated to scroll the table.

19. The method of claim 18, further comprising:
receiving a scroll command to scroll the displayed portion of the table; and
the storing information step includes storing information regarding the portion of the table that was output for display when the scroll command was received.

20. The method of claim 18, further comprising:
designating a predetermined recording unit from the displayed portion of the table;
reproducing the designated recording unit; and
outputting the portion of the table listing the designated recording unit after the designated recording unit is reproduced.

21. The method of claim 18, further comprising:
designating a predetermined recording unit from the displayed portion of the table;
reproducing the designated recording unit; and
outputting a portion of the table containing recording units stored either before or after the designated recording unit after reproduction of the designated recording unit.

22. The method of claim 18, wherein said image information is bit-map data of a photographed object.

23. The method of claim 18, wherein said memo information is bit-map data of a line drawing.

24. The method of claim 18, wherein said method is performed in an electronic camera that:
photographs an object to input bit-map data of an object as said image information; and
inputs line drawing information as said memo information.

25. The method of claim 24, wherein said electronic camera also:
inputs said sound information through a microphone.

26. The information displaying apparatus according to claim 1, wherein the information displaying apparatus is a camera.

27. The information displaying apparatus according to claim 9, wherein the information displaying apparatus is a camera.
